(19) United States
(12) Patent Application Publication
(10) Pub. No.: US 2016/0361943 A1
(43) Pub. Date: Dec. 15, 2016

(54) SPRAY TACTICAL PEN

(71) Applicants: Malia C. Rogers, Hayden, ID (US); Christopher S. Rogers, Hayden, ID (US)

(72) Inventors: Malia C. Rogers, Hayden, ID (US); Christopher S. Rogers, Hayden, ID (US)

(21) Appl. No.: 15/182,594

(22) Filed: Jun. 15, 2016

Related U.S. Application Data
(60) Provisional application No. 62/175,446, filed on Jun. 15, 2015.

(51) Int. Cl. B43K 29/00; F41H 9/10

(52) U.S. Cl. CPC B43K 29/00; F41H 9/10

(57) ABSTRACT

The current invention is a non-lethal personal defense combination of tactical pen and spray dispenser that has the writing capabilities of a pen and ability to use one end as a window breaker. The tactical pen body is made of aircraft aluminum or similar durable material for strength and textured in the middle for extra grip when striking the assailant. On one end, the spray nozzle swivels open, similar to tops of spray-on sunscreen, to protect from accidental dispense and the ability to unlock with one hand. The embodiment's clip is configured to secure to any material that would give the user quick access, such as jacket, shirt or pant pockets, purse or a vehicle visor.

### CROSS-REFERENCES TO RELATED APPLICATIONS

This application claims the priority date of Provisional Application No. 62/175,446 filed on Jun. 15, 2015.

### BACKGROUND

1. Field of the Invention

This invention relates to non-lethal self-defense devices as used by law enforcement, military personnel or the general public for personal protection, and particularly, to a device which may be utilized as a tactical pen or self-defense spray.

2. Description of Prior Art

Non-lethal weapons may be used in circumstances where conventional weapons are restricted and can be used in combat situations to limit the escalation of conflict. Batons, tactical pens, and portable spray dispensers have been commonly used as forms of self-defense.

An expandable baton that has spray dispensing capabilities described in U.S. Pat. No. 7,744,471 of Parsons (2003) allows the user to immediately escalate from the use of a chemical irritant to the use of an impact weapon. Limitations include bulkiness, making it non-discreet and cumbersome to carry, as opposed to something that can be carried in a shirt pocket or purse. This same limitation applies to U.S. Pat. No. 5,086,377 of Roberts in 1991 (FIG. 6 demonstrates the size of the device) which discloses a baton-like housing with audible/visible alarm and a flashlight, with a replaceable aerosol defense spray container with nozzle and actuator positioned to aim the spray away from the user and toward an assailant when grip is properly grasped. Roberts' patent also requires the user to grip the device a specific way and proper place, requiring training prior to spray feature use.

U.S. Pat. No. 5,529,215 of Banks & Taylor (1995) describes a personal defense baton that includes a defense spray container, with a clip used for securing to a pocket, making it more readily accessible. One disadvantage include having to remove the cap over the pump of this dispenser before the contents of the spray can be expelled. One additional limitation to this device also applies to U.S. Pat. No. 7,178,696 by Larsen, Christensen and Pellegrino (2004) which describes a portable container with a clip secured to the spray head. There is no additional practical uses for these devices, so the likelihood of the average consumer consistently carrying this device on a daily basis is unlikely.

As demonstrated above, there are several types of personal defense devices available. Some of these include an element of personal defense spray combined with use of baton, however they are bulky, awkward, inconvenient or do not provide additional usefulness as extra incentive for the user to carry for personal protection. Therefore the present invention is focused on a device that is easily accessible, more readily available, with additional useful and practical benefits to encourage the user to consistently carry the device.

There is still room for improvement in the art.

### SUMMARY OF THE INVENTION

A non-lethal personal defense combination of tactical pen and spray dispenser that has the writing capabilities of a pen and ability to use one end as a window breaker. The tactical pen body is made of aircraft aluminum or similar durable material for strength and textured in the middle for extra grip and cap designed for striking the assailant in any soft tissue body parts, such as eyes, ears, neck, groin, etc. On one end, the spray nozzle swivels open, similar to tops of spray-on sunscreen, to protect from accidental dispense and the ability to unlock with one hand. The embodiment's clip is configured to secure to any material that would give the user quick access, such as jacket, shirt or pant pockets, purse, or a vehicle visor. The tactical pen twists open, for access to the refillable ink cartridge & interchangeable spray cartridge, which can be filled with, but not limited to defensive spray or can be replaced with a solid or empty cartridge for compliance when traveling by air. The personal defense spray used to defend oneself without getting too close to an assailant. On the other end, the cap snaps on, shaped with a pointed end, therefore can be used as a window breaker in the event needed. The pen fully functions as a writing utensil and can be carried inconspicuously and in a non-threatening manner by professionals that work with the general public, military personnel, law enforcement agents or any consumer concerned with personal safety.

### BRIEF DESCRIPTION OF THE DRAWINGS

Without restricting the full scope of this invention, the preferred form of this invention is illustrated in the following drawings:

FIG. 1 is a perspective side view of the preferred embodiment;

FIG. 2 is an exploded perspective side view of the embodiment;

FIG. 3 is a realistic rendering side view of the embodiment with the cap on; and

FIG. 4 is a realistic rendering view of the embodiment with the cap off, revealing the pen tip

### DESCRIPTION OF THE PREFERRED EMBODIMENT

There are a number of significant design features and improvements incorporated within the invention.

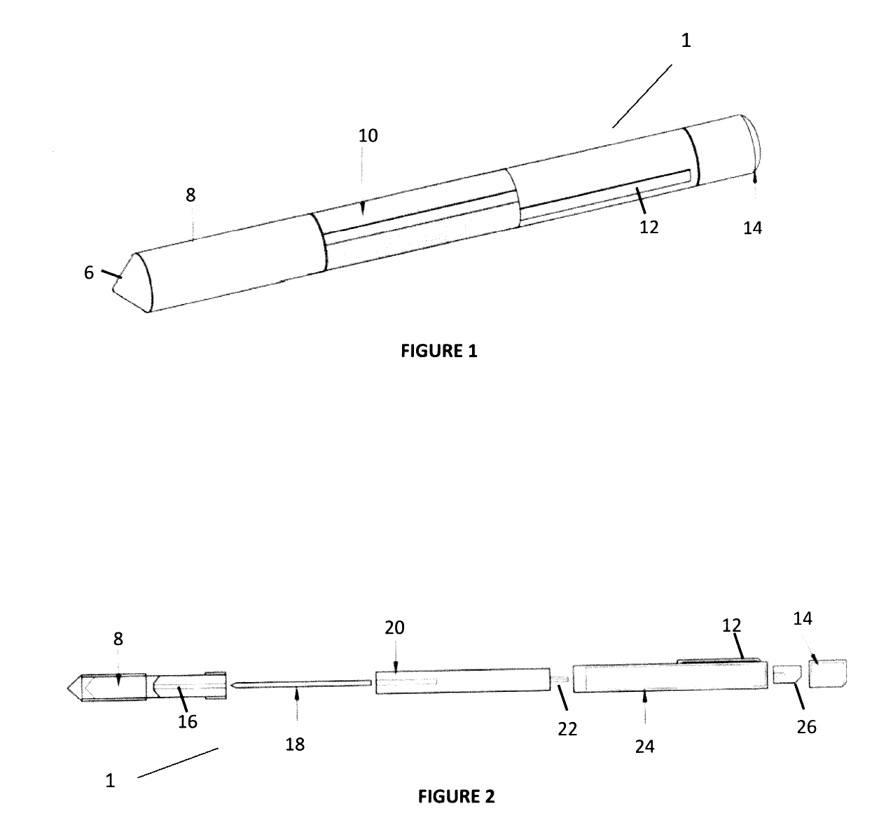

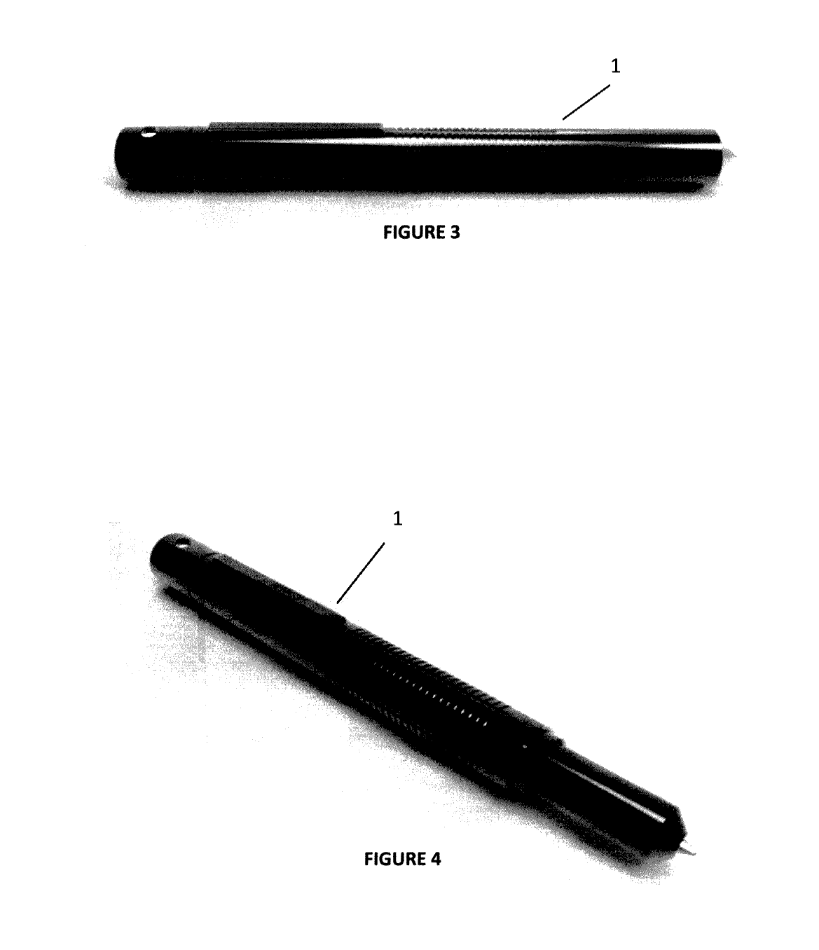

The present invention is a spray tactical pen 1, as shown in FIGS. 1 through 4.

FIG. 1 shows the visible components of the preferred embodiment. The pen 1 would have a the total length ideally approximately six inches. The pen 1 would have a cyclical body 10, made of aircraft aluminum or similar material strength which has a texture surface for added grip. The body 10 includes a clip 12 to secure to any thin material convenient to the user such as a shirt pocket such as jacket, shirt or pant pockets, purse or a vehicle visor.

A cap 8, made of either aircraft aluminum or similar material strength that snaps on to the body 10 on one end of the body covering a writing point. The cap 8 has a pointed metal tip 6. The metal tip can be used to break windows if the need arises. On the other end of the body 10, the pen 1 has a spray nozzle safety cap and actuator 14. The spray nozzle swivels open and close and includes a depression surface similar to the top of some sunscreen spray bottles and in the preferred embodiment has a slightly slanted side (not shown), so user knows which direction the spray nozzle is pointed.

The pen 1 functions as a pen for practical use on a daily basis. FIG. 2 illustrates how the embodiment is assembled. An ink feed tube 16 is made of metal for added reinforcement. An ink cartridge 18 is similar, but not limited to Hartley Racon's ink Dl cartridge. The ink feed tube 16 connects to a ink cartridge 18 and has a ball point writing point like a ball point pen. The ink cartridge 18 provides ink to the ball point writing point allowing the pen 1 to write.

The tactical pepper pen 1 has a spray container 20 within the body 10. This spray container 20 is intended, but not limited to personal defense spray and can be temporarily replaced with a solid or empty container for air travel compliance. A valve stem 22 in the spray container 20 is fed into a hole at the end of an upper barrow 24 of the pen 1 and then attached to the spray nozzle 26. The upper barrel 24 is made of aircraft aluminum for strength and sturdiness and is where the pocket clip 12 is attached. The spray nozzle 26 will be covered by the spray nozzle safety cap and actuator 14, as shown in FIG. 1. The spray container 20 can be indented to make room for a longer ink cartridge 18 if desired.

The tactical pen 1 unscrews for easy access to the ink and spray cartridges.

The tactical pepper pen 1 is made of aircraft aluminum (or similar metal/heavy material) for physical impact on any soft tissue (eyes, throat, ears, neck, groin, etc). It has the overall look and size is non threatening and convenient to carry.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A non-lethal personal defense device comprising:
a cylinder body with a spray cartridge connected to a spray nozzle and an ink cartridge connected to a writing tip.

2. A non-lethal personal defense device according to claim 1 further comprising:
having a safety cap.

3. A non-lethal personal defense device according to claim 2 further comprising:
said safety cap has a pointed metal tip.

4. A non-lethal personal defense device according to claim 1 further comprising:
having a clip.

5. A non-lethal personal defense device according to claim 1 further comprising:
having a texture surface.

6. A non-lethal personal defense device according to claim 1 further comprising:
made of aircraft aluminum.

7. A non-lethal personal defense device according to claim 1 further comprising:
where the spray nozzle is covered by a spray nozzle safety cap and actuator.

8. A non-lethal personal defense device according to claim 1 further comprising:
where the spray container is removable.

9. A non-lethal personal defense device according to claim 1 further comprising:
where the spray container has a personal defense spray.

10. A non-lethal personal defense device according to claim 1 further comprising:
where the spray container has a valve stem that is fed into a hole at the end of an upper barrow and then attached to the spray nozzle.

11. A non-lethal personal defense device according to claim 10 further comprising:
having a pocket clip attached to the upper barrel.

12. A non-lethal personal defense device according to claim 1 further comprising:
an ink feed tube connects the ink cartridge to the writing point.

13. A non-lethal personal defense device comprising:
a cylinder body having a clip with a removable spray cartridge connected to a spray nozzle and an ink cartridge connected to a writing tip having a safety cap have a pointed metal tip where the spray nozzle is covered by a spray nozzle safety cap and actuator.

14. A non-lethal personal defense device according to claim 13 further comprising:
having a texture surface.

15. A non-lethal personal defense device according to claim 13 further comprising:
made of aircraft aluminum.

16. A non-lethal personal defense device according to claim 13 further comprising:
where the spray container has a personal defense spray.

17. A non-lethal personal defense device according to claim 13 further comprising:
where the spray container has a valve stem that is fed into a hole at the end of an upper barrow and then attached to the spray nozzle.

18. A non-lethal personal defense device according to claim 13 further comprising:
an ink feed tube connects the ink cartridge to the writing point.
